(19) United States
(12) Patent Application Publication
(10) Pub. No.: US 2012/0218787 A1
(43) Pub. Date: Aug. 30, 2012

(54) STABILIZED VOLTAGE POWER SUPPLY

(75) Inventor: Qilin Fan, Shanghai (CN)

(73) Assignee: RICOH COMPANY, LTD., Tokyo (JP)

(21) Appl. No.: 13/367,724

(22) Filed: Feb. 7, 2012

(30) Foreign Application Priority Data
Feb. 28, 2011 (CN) 201110056494.1

(51) Int. Cl. H02M 3/335

(52) U.S. Cl. 363/21.15; 363/21.17

(57) ABSTRACT

Disclosed is a stabilized voltage power supply comprising an A/D converting circuit configured to convert an alternate current voltage received from an external power supply to an initial direct current voltage; a PWM signal output unit configured to generate and output a PWM signal; a control switch configured to alternatively carry out, based on control of the received PWM signal, switching between a turn-on state and a turn-off state so as to convert the initial direct current voltage to a pulse voltage whose duty ratio is the same with that of the PWM signal; a final converting circuit configured to convert the pulse voltage to a final direct current voltage, and output the final direct current voltage to an external load via an output terminal; and a feed unit configured to feed the final direct current voltage back to the PWM signal output unit.

### BACKGROUND OF THE INVENTION

1. Field of the Invention

The present invention relates to a stabilized voltage power supply.

2. Description of the Related Art

In an electrical apparatus such as an image forming device, etc., there are two or more components in general. Also operating voltages needed by the components may be different.

In conventional techniques, a normal method is dividing, by using two or more power supply converting devices, a direct current output obtained by rectifying alternating current such as a 220V alternating current, into at least one main power supply output and an assistant power supply output. The main power supply output is used to provide stabilized direct voltage (for example, 24V) to at least one motor or the like in an electrical apparatus. The assistant power supply output is utilized to provide electrical power (for example, 5V direct current) to a CPU in the electrical apparatus. FIG. 7 illustrates a circuit of a main power supply 71 and an assistant power supply 72 in the conventional techniques for respectively providing electrical powers to a driving unit 73 and a CPU 74.

As the number of components in an electrical apparatus needing electrical power increases, it is necessary to dispose many power supply converting devices; each of the power supply converting devices may be similar to the circuit shown in FIG. 7. In addition, each of the power supply converting devices needs to have a pulse width modulation integrated circuit 76 (PWM_IC). FIG. 8 illustrates an example of a PWM_IC in the conventional techniques.

In the conventional techniques, if a power supply used for an electrical apparatus is set according to the above described method, there may be disadvantages as follows:

(1) Each of the power supply converting devices needs to include a PWM_IC, thereby undoubtedly increasing cost of manufacturing the electrical apparatus as well as increasing structural complexity of the electrical apparatus.

(2) In order to achieve a stabilized voltage output, it is necessary to carry out feedback control. Automatic adjustment of a duty ratio of a PWM signal needs to be performed by utilizing a circuit in the PWM_IC. At the same time, it is necessary to introduce a reference voltage providing component similar as shown in FIG. 9 into the PWM_IC. These may further increase the cost of manufacturing the electrical apparatus.

(3) The PWM_IC in the conventional techniques is not capable of executing malfunction detection.

(4) A few functions of a CPU originally being in the electrical apparatus may not be effectively utilized, thereby resulting in resource wasting.

### SUMMARY OF THE INVENTION

The present invention is proposed in order to overcome the above described one or more disadvantages of the prior art.

The aim of the present invention is to provide an easily controlled stabilized voltage power supply having a simple structure and low cost.

According to one aspect of the present invention, a stabilized voltage power supply is provided. The stabilized voltage power supply comprises an alternate current voltage to direct current voltage (A/D) converting circuit, a control switch, a final converting circuit, a feedback unit, and a pulse width modulation (PWM) signal output unit. The A/D converting circuit is configured to convert an alternate current voltage received from an external power supply to an initial direct current voltage. The PWM signal output unit is configured to generate and output a PWM signal. The control switch is configured to alternatively carry out, based on control of the received PWM signal, switching between a turn-on state and a turn-off state so as to convert the initial direct current voltage to a pulse voltage whose duty ratio is the same with that of the PWM signal. The final converting circuit is configured to convert the pulse voltage to a final direct current voltage, and output the final direct current voltage to an external load via an output terminal. The final direct current voltage changes in a direction being the same with that of the duty ratio of the PWM signal. The feed unit is configured to feed the final direct current voltage back to the PWM signal output unit, and include a sampling unit configured to obtain a sample voltage from the output terminal of the final converting circuit, proportional to the final direct current voltage, and carry out alternate current voltage to direct current voltage (A/D) conversion with regard to the obtained sample voltage; a voltage comparing unit configured to perform comparison between the sample voltage after the A/D conversion and a digital reference voltage; and a duty ratio adjusting unit configured to adjust, based on the comparison result of the voltage comparing unit, the duty ratio of the PWM signal. If the sample voltage after the A/D conversion is equal to the reference voltage, then the duty ratio adjusting unit does not change the duty ratio of the PWM signal; if the sample voltage after the A/D conversion is greater than the reference voltage, then the duty ratio adjusting unit decreases the duty ratio of the PWM signal by a first predetermined value; and if the sample voltage after the A/D conversion is less than the reference voltage, then the duty ratio adjusting unit increases the duty ratio of the PWM signal by a second predetermined value.

### BRIEF DESCRIPTION OF THE DRAWINGS

FIG. 1 illustrates a circuit including an example of a stabilized voltage power supply according to a first embodiment of the present invention;

FIG. 2 is an operational flowchart of a PWM signal output unit and a feedback unit according to an embodiment of the present invention;

FIG. 3 illustrates a circuit including an example of a stabilized voltage power supply according to a second embodiment of the present invention;

FIG. 4 illustrates an example of a photoelectric coupler used in a stabilized voltage power supply according to an embodiment of the present invention;

FIG. 5 is an operational flowchart of a malfunction detecting unit used in a stabilized voltage power supply according to a third embodiment of the present invention;

FIG. 6 is an operational flowchart of a malfunction detecting unit used in a variant stabilized voltage power supply according to the third embodiment of the present invention;

FIG. 7 illustrates a circuit of a main power supply and an assistant power supply for respectively providing electrical powers to a driving unit and a CPU, in the conventional techniques;

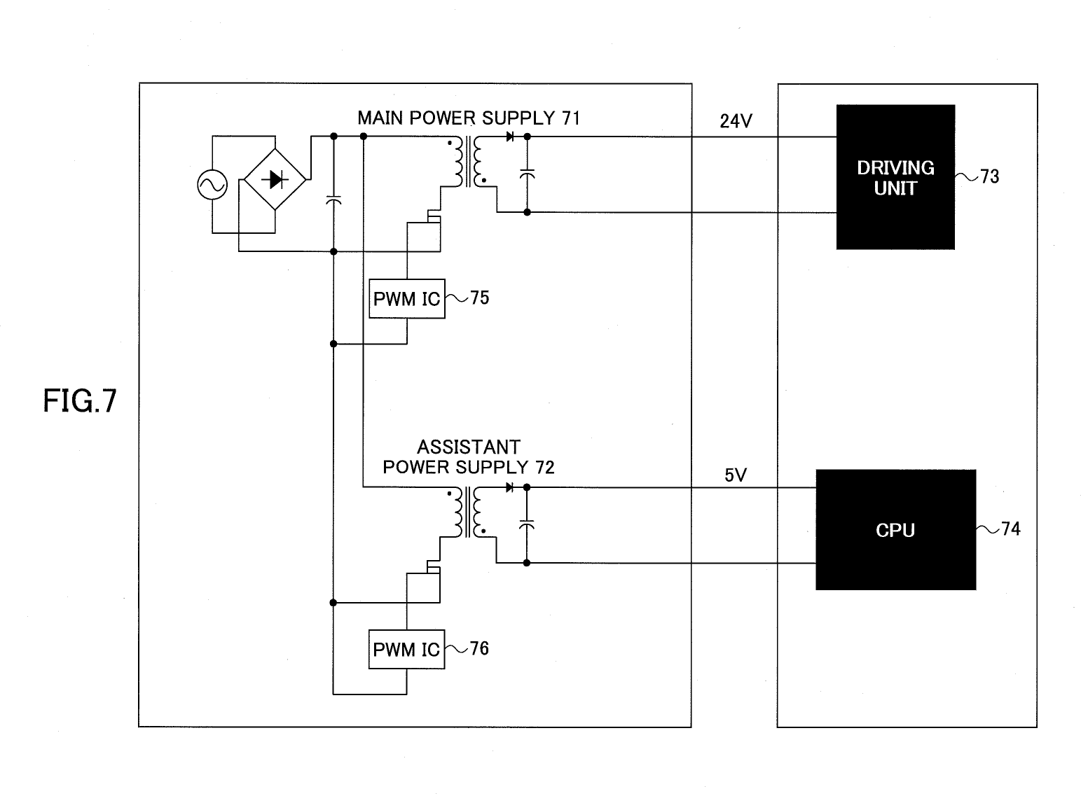

FIG. 8 illustrates an example of a PWM_IC in the conventional techniques; and

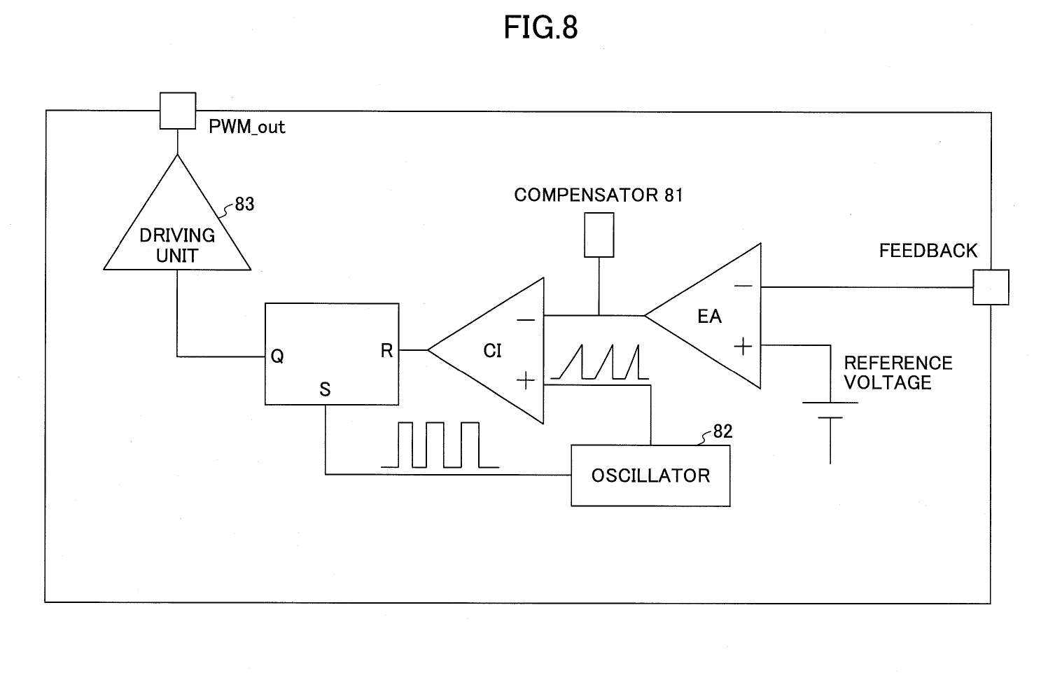

FIG. 9 illustrates an example of a reference voltage providing component set for a PWM_IC, in the conventional techniques.

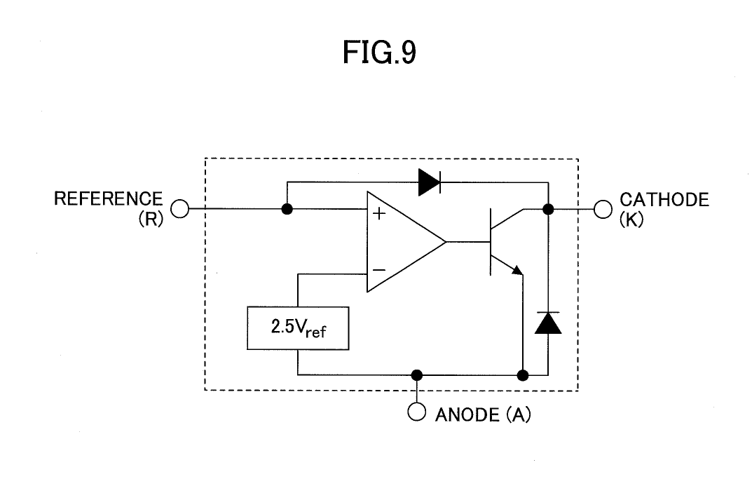

### DETAILED DESCRIPTION OF THE PREFERRED EMBODIMENTS

Hereinafter, various embodiments of the present invention will be concretely described with reference to the drawings. However it should be noted that the same symbols, which are in the specification and the drawings, stand for constructional elements having the basically-same function and structure, and repeated explanations for the constructional elements are omitted.

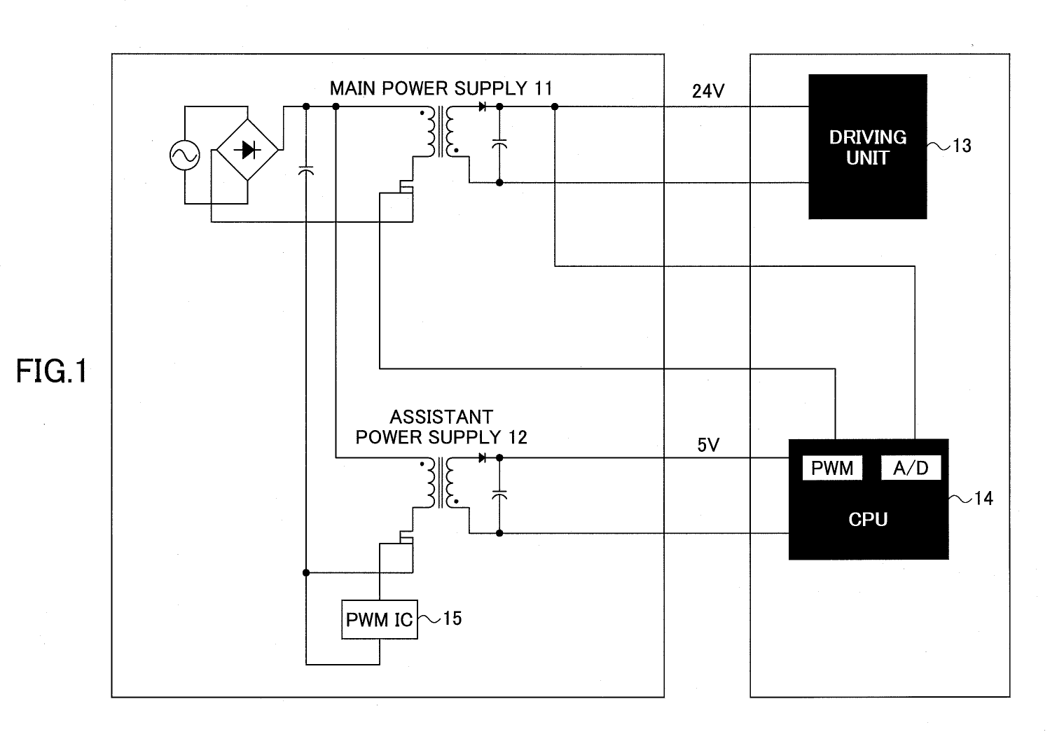

FIG. 1 illustrates a circuit including an example of a stabilized voltage power supply according to a first embodiment of the present invention.

The stabilized voltage power supply according to the first embodiment of the present invention has a power main supply 11 for providing electrical power to a driving unit 13 as shown in FIG. 1. Also an assistant power supply (hereinafter known as a conventional stabilized voltage power supply) 12 having a PWM_IC 15, serving as an assistant power supply for providing electrical power to a CPU 14 is shown in FIG. 1. The conventional stabilized voltage power supply 12 having the PWM_IC 15 is used for providing the electrical power to the CPU 14 so that the CPU 14 may serve as another stabilized voltage power supply in a PWM signal output unit control device as concretely described below. Since the conventional stabilized voltage power supply 12 serving as the assistant power supply is not a component needing to be improved in the present invention, description of the conventional stabilized voltage power supply 12 is omitted here.

The stabilized voltage power supply shown in FIG. 1 includes a rectifying and smoothing circuit (serving as an example of an A/D converting circuit), a metal oxide semiconductor field effect transistor (MOSFET) (serving as an example of a control switch), a DC-DC converter (serving as an example of a final converting circuit), a feedback unit fulfilled by combining hardware (for example, a CPU) and software, and a PWM signal output unit. In this embodiment, an example of the PWM signal output unit is a clock pulse generator of a CPU; the clock pulse generator generates and outputs a pulse signal serving as a PWM signal. As an example of the feedback unit, a feedback unit according to an embodiment of the present invention includes an A/D converter of a CPU, a unit achieved by combining a CPU and software for carrying out voltage comparison, a unit for controlling a clock pulse, and a necessary feedback circuit connected between an output terminal of a DC-DC converter and an A/D converter. In this embodiment, the feedback circuit directly shorts the output terminal of the DC-DC converter and the A/D converter.

The rectifying and smoothing circuit converts alternating voltage from an external power supply into initial direct voltage Vi. An output terminal of the PWM signal output unit is connected to a gate of the MOSFET (an control terminal). The control switch alternatively executes, based on the received PWM signal, switching between a turn-on state and a turn-off state so that the initial direct voltage Vi may be converted into pulse voltage Vp whose duty ratio is the same with that of the PWM signal. In particular, at a high level of the PWM signal, the MOSFET turns on (a turn-on state); at a low level of the PWM signal, the MOSFET turns off (a turn-off state). In this way, the pulse voltage Vp may be applied to an input terminal of the DC-DC converter.

The DC-DC converter includes a voltage inverter and a rectifying and smoothing circuit so that the pulse voltage Vp may be converted into final direct voltage Vo which is provided via the output terminal of the DC-DC converter to a driving unit 33 in an electrical apparatus, serving as an example of an external load.

The relationship among a value of the final direct voltage Vo, a value of the pulse voltage Vp, and a duty ratio D of the pulse signal is as follows: Vo=Vp×ton/toff. Here ton refers to conduction time (turn-on time) of the MOSFET, i.e., a time period in which the PWM signal is at a high level; toff refers to down time (turn-off time) of the MOSFET, i.e., a time period in which the PWM signal is at a low level. If a switching period is expressed as T, then T=ton+toff, ton=T×D, and toff=T−ton=T×(1−D). In other words, Vo=Vp×D/(1−D).

In so doing, if the width of the pulse signal is unchanged (constant), then the greater the duty ratio of the pulse is, the greater the final direct voltage is, and vice versa. As a result, the final direct voltage Vo changes according to the duty ratio of the PWM signal, i.e., changes in a direction being the same with (for example, proportionally with) that of the duty ratio of the PWM signal.

The feedback unit feeds the final direct voltage Vo back to the PWM signal output unit, and carries out, based on a ratio of the final direct voltage Vo to reference voltage Vs, control with regard to the duty ratio of the PWM signal so as to render the final direct voltage Vo stable.

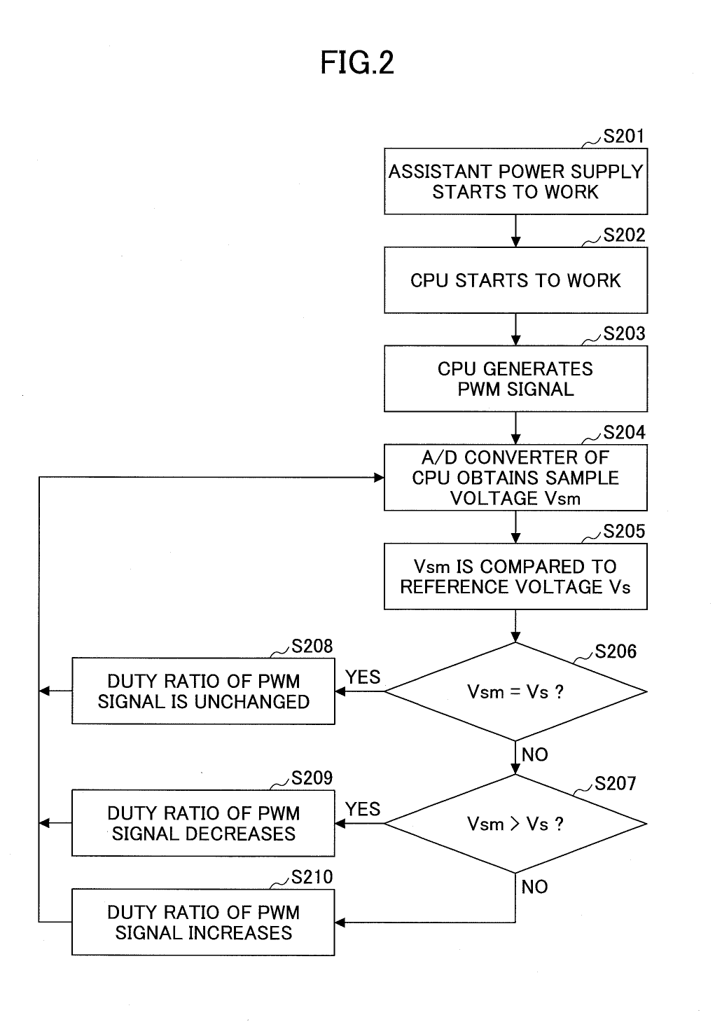

FIG. 2 is an operational flowchart of a PWM signal output unit and a feedback unit according to an embodiment of the present invention.

In STEP S201, first an assistant power supply starts to work. Immediately after that, in STEP S202, a CPU starts to work. Then, in STEP S203, a clock pulse generator of the CPU, serving as an instance of the PWM signal output unit, generates a PWM signal.

In STEP S204, an A/D converter serving as an example of a sampling unit obtains sample voltage Vsm that is the same with a final direct voltage Vo from an output terminal of a DC-DC converter, and then performs A/D conversion with regard to the sample voltage Vsm. Here it should be noted that in another embodiment, it is possible to render the sample voltage Vsm and the final direct voltage Vo proportionally by adopting a voltage dividing circuit, etc.

In STEP S205, the sample voltage Vsm after the A/D conversion is compared to a digital reference voltage Vs predetermined in the CPU. In this embodiment, it is preferred that the digital reference voltage Vs be equal to voltage output by the stabilized voltage power supply in a normal operation mode.

Next a duty ratio of the PWM signal is adjusted based on the comparison result of STEP S205.

In particular, if the sample voltage Vsm is equal to the digital reference voltage Vs (i.e., the determination result of STEP S206 is “YES”), then a PWM duty ratio adjusting unit does not change the duty ratio of the PWM signal (STEP 208). At this time, the PWM signal generated by the clock pulse generator is directly output.

If the sample voltage Vsm is greater than the digital reference voltage Vs (i.e., the determination result of STEP S207 is “YES”), then the PWM duty ratio adjusting unit decreases the duty ratio of the PWM signal by a first predetermined value (STEP S209). Based on this adjustment, the clock pulse generator outputs the PWM signal whose duty ratio has been adjusted.

If the sample voltage Vsm is less than the digital reference voltage Vs (i.e., the determination result of STEP S207 is “NO”), then the PWM duty ratio adjusting unit increases the duty ratio of the PWM signal by a second predetermined value (STEP S210). Based on this adjustment, the clock pulse generator outputs the PWM signal whose duty ratio has been adjusted.

Here it should be noted that the first and second predetermined values, by which the duty ratio of the PWM signal decreases and increases, may be predetermined based on actual needs. As a proposal, the first and second predetermined values may be fixedly set to be in predetermined proportions to the currently adjusting duty ratio of the PWM signal, respectively. For example, the predetermined values may be 5% or 10% of the currently adjusting duty ratio of the PWM signal. Here it should be noted that the first and second predetermined values may be the same or different. As another proposal, the first and second predetermined values may be set to be in predetermined proportions to a difference value of the sample voltage Vsm and the digital reference voltage Vs, respectively. For example, when the difference value of Vsm and Vs is equal to or greater than or equal to 1V, the first and/or second predetermined values may be 1% of the currently adjusting duty ratio of the PWM signal; when the difference value of Vsm and Vs is less than 0.5V, the first and/or second predetermined values may be 0.5% of the currently adjusting duty ratio of the PWM signal.

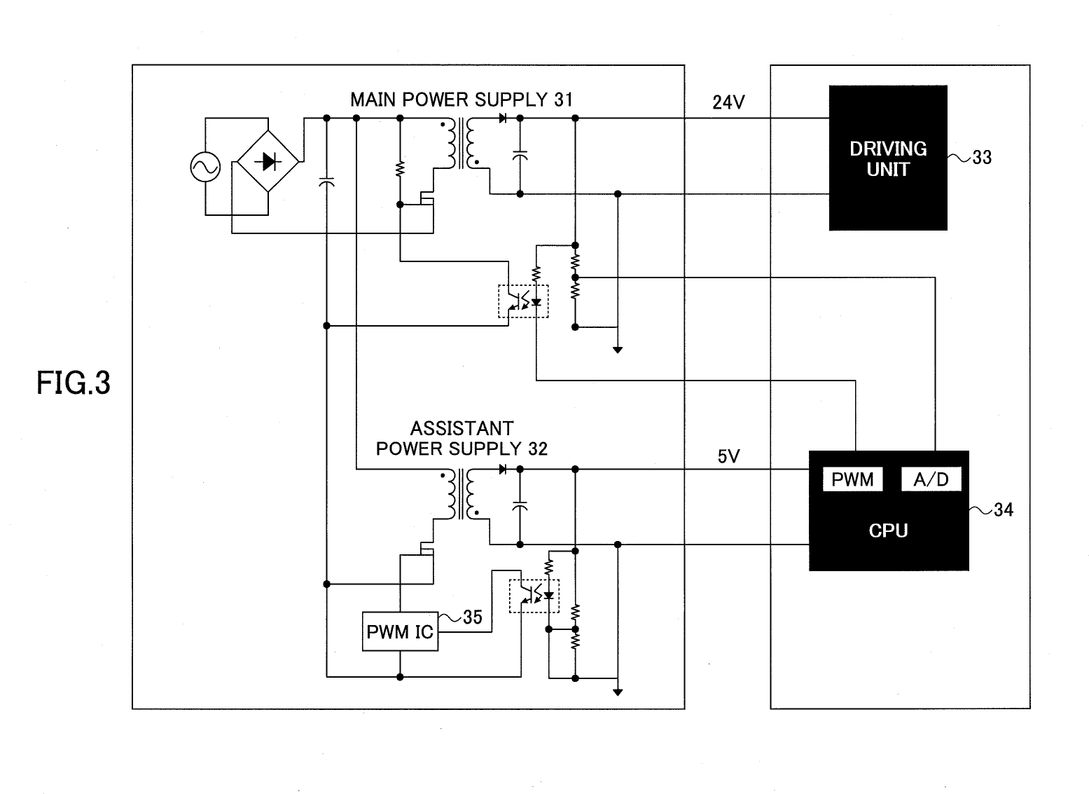

In what follows, a stabilized voltage power supply according to a second embodiment of the present invention is described by referring to FIG. 3.

FIG. 3 illustrates a circuit including an example of the stabilized voltage power supply according to the second embodiment of the present invention.

Here it should be noted that the following description is only focused on differences of the second embodiment and the first embodiment.

In a feedback unit of the stabilized voltage power supply according the second embodiment, a voltage dividing circuit is connected between an output terminal of a DC-DC converter and an A/D converter; the voltage dividing circuit includes two resistances whose resistance values are the same. By using the voltage dividing circuit, voltage received by the A/D converter is ½ of a final direct voltage Vo.

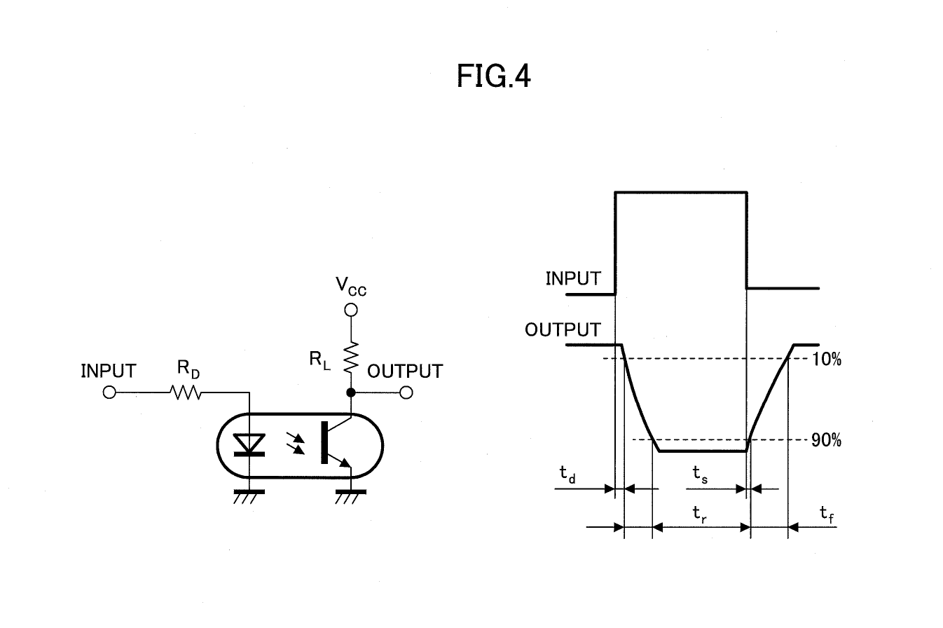

Furthermore, on the primary side of the DC-DC converter, i.e., on the side where a voltage inverter exists, high voltage (for example, 220V), that may hurt operators of an electrical apparatus or components in the electrical apparatus, is connected to the DC-DC converter; on the secondary side of the DC-DC converter, low voltage is output. As a result, for purpose of safety, it is necessary to render the primary side and the secondary side separate. In the second embodiment, a photoelectric coupler that may be the same as shown in FIG. 4 is adopted.

FIG. 4 illustrates an example of a photoelectric coupler used in a stabilized voltage power supply according to an embodiment of the present invention.

In the example of the photoelectric coupler shown in FIG. 4, the photoelectric coupler consists of a light emitting diode (LED) on the input side and an optical receiver such as a phototransistor, on the output side. The photoelectric coupler includes an input terminal of the LED, serving as an instance of a high level terminal on the input side; an output terminal of the LED, serving as an instance of a low level terminal on the input side; an output terminal of the phototransistor, serving as an instance of a high level terminal on the output side; and another output terminal of the phototransistor, serving as an instance of a low level terminal on the output side.

The high level terminal on the output side of the photoelectric coupler is connected to a gate of a MOSFET serving as an instance of a control switch, and is connected to an output terminal of an A/C converting circuit via a resistance; the low level terminal on the output side of the photoelectric coupler is connected to ground; the high level terminal on the input side of the photoelectric coupler is connected to an output terminal of a DC-DC converter via another resistance; and the low level terminal on the input side of the photoelectric coupler is connected to an output terminal of a PWM signal output unit. In this way, the primary side and the secondary side of the stabilized voltage power supply are totally separate so that the operators of the electrical apparatus and the components such as a CPU, a driving unit, etc., in the electrical apparatus may be properly protected.

In what follows, a stabilized voltage power supply according to a third embodiment of the present invention is described.

In the stabilized voltage power supply according to the third embodiment of the present invention, a malfunction detecting unit is further included. If the malfunction detecting unit detects that sample voltage Vsm is out of a predetermined voltage range including a reference voltage Vs, and a predetermined time period expires, then the malfunction detecting unit outputs a malfunction notification signal, and controls a clock pulse generator to stop output of a PWM signal.

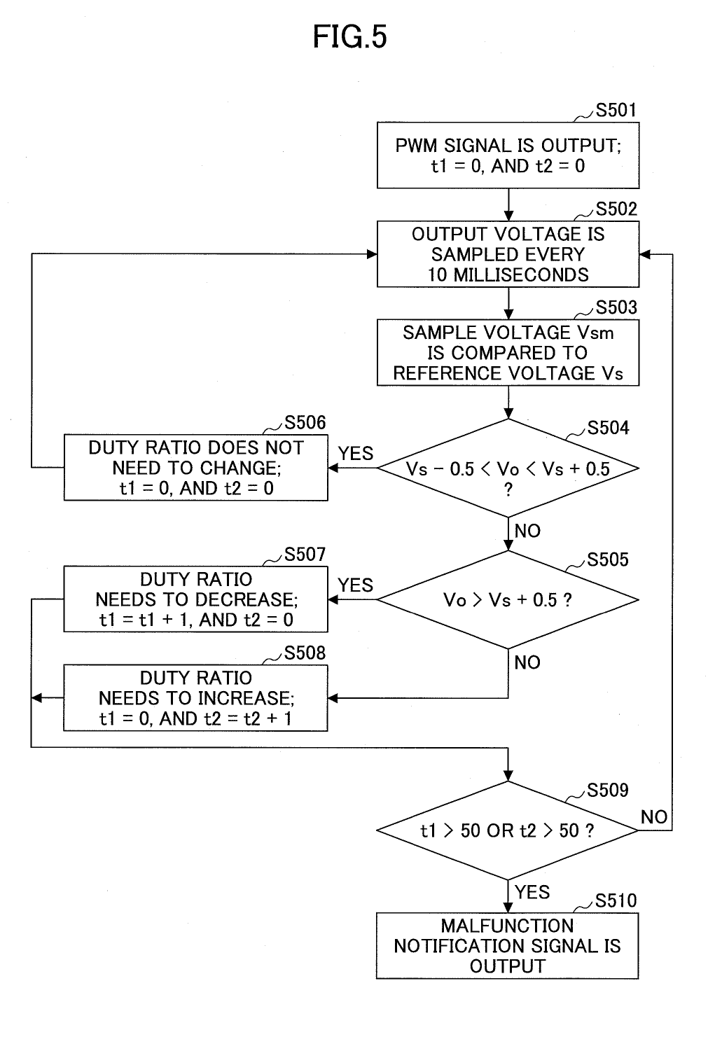

FIG. 5 is an operational flowchart of the malfunction detecting unit used in the stabilized voltage power supply according to the third embodiment of the present invention.

In STEP S501, a PWM signal is output; at the same time, count values t1 and t2 are set to 0, i.e., t1=0, and t2=0.

In STEP S501, sampling and its corresponding A/D conversion are carried out with regard to output voltage Vo every 10 milliseconds (ms) (i.e., a predetermined detection time period).

Next, in STEP S502, the output voltage Vo after the A/D conversion is compared to a reference voltage (also called “target voltage”) Vs.

If a relationship of Vo and Vs satisfies Vs −0.5<Vo<Vs+0.5 (i.e., the determination result of STEP S504 is “YES”), then a duty ratio of the PWM signal does not need to change, and t1 and t2 are set to 0, i.e., t1=0, and t2=0.

If Vo is greater than Vs+0.5 (i.e., the determination result of STEP S505 is “YES”), then the duty ratio of the PWM signal needs to decrease, and at the same time, t1=t1+1. Then, in STEP S509, it is determined whether t1 is greater than 50. If the determination result is “NO”, then processing goes back to STEP S502. In the subsequent steps, as long as Vo and Vs satisfies Vs−0.5<Vo<Vs+0.5, t1 is set to 0, i.e., t1=0. Otherwise t1 is incremented by 1 continuously, and if it is determined in STEP S509 that t1 is greater than 50, i.e., a duration of a state where the duty ratio of the PWM signal needs to be adjusted exceeds 500 ms, then the malfunction detecting unit outputs a malfunction notification signal, and controls the clock pulse generator to stop output of the PWM signal.

In a case where Vo is less than Vs−0.5, a malfunction detecting process is similar to that in the case where Vo is greater than Vs+0.5. However, the difference is that t2 is considered a count value, i.e., t2=t2+1. If t2>50, then the malfunction detecting unit outputs a malfunction notification signal by which the operators of the electrical apparatus may know that a malfunction in the electrical apparatus has occurred, and controls the clock pulse generator to stop output of the PMW signal.

Here it should be noted that the above mentioned voltage range (Vs−0.5, Vs+0.5) is just an example of the predetermined voltage range including the reference voltage Vs, and the above mentioned 500 ms is just an example of the duration (i.e., the predetermined time period) too. In other words, the predetermined voltage range and/or length of the duration may be set based on actual needs.

In so doing, the malfunction detecting unit according to the third embodiment of the present invention detects a relationship of the sample voltage Vsm and the predetermined voltage range every predetermined detection time period, for example, 10 ms. If the number of times successively detecting that the sample voltage Vsm is out of the predetermined voltage range, is greater than a predetermined number of times, for example, 50, then that means the duty ratio of the PWM signal is out of a predetermined duty ratio range, and a predetermined time period, for example, 500 ms, expires. As a result, the malfunction detecting unit outputs a malfunction notification signal, and controls the clock pulse generator to stop output of the PWM signal.

In what follows, a variant stabilized voltage power supply according to the third embodiment of the present invention is described.

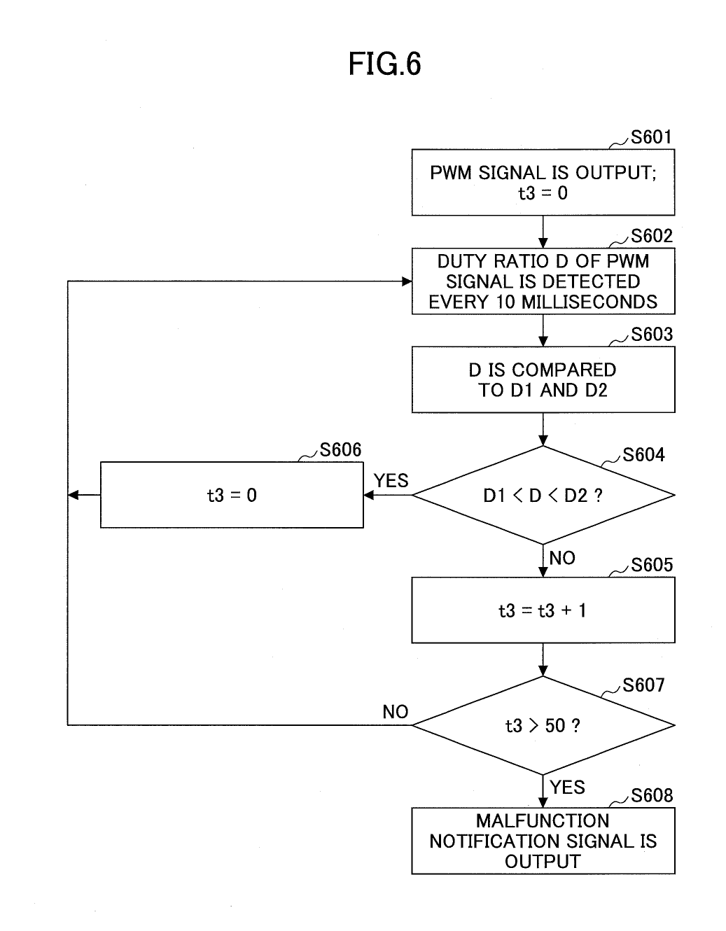

FIG. 6 is an operational flowchart of a malfunction detecting unit used in the variant stabilized voltage power supply according to the third embodiment of the present invention.

If the malfunction detecting unit detects that a duty ratio of a PWM signal is out of a predetermined duty ratio range, and a predetermined time period expires, then the malfunction detecting unit outputs a malfunction notification signal, and controls a clock pulse generator to stop output of the PWM signal. The predetermined duty ratio range includes a duty ratio corresponding to a reference voltage.

In STEP S601, a PWM signal is output; at the same time, t3 is set to 0, i.e., t3=0. In STEP S602, a duty ratio D of the output PWM signal is detected every 10 ms (i.e., a predetermined detection time period).

Next, in STEP S603, the duty ratio D of the PWM signal is compared to an upper limit D1 and a lower limit D2 of a predetermined duty ratio range, respectively so as to determine whether the duty ratio D is within the predetermined duty ratio range. Here the upper limit D1 refers to a duty ratio of the PWM signal when output voltage is equal to a value of adding a margin (for example, 0.5 V) to reference voltage Vs. The lower limit D2 refers to a duty ratio of the PWM signal when the output voltage is equal to a value of subtracting a margin (for example, 0.5 V) from the reference voltage Vs.

If the duty ratio D is within the predetermine duty ratio range (i.e., the determination result of STEP S604 is “YES”), then t3 is set to 0, i.e., t3=0 (STEP S606). Otherwise (i.e., the determination result of STEP S604 is “NO”), in STEP S605, t3 is set to t3+1, i.e., t3=t3+1.

Next, in STEP S607, it is determined whether t3 is greater than 50. If the determination result of STEP S607 is “NO”, then processing goes back to STEP S602, and then, in the subsequent steps, as long as the duty ratio D is within the predetermined duty ratio range, t3 is set to 0, i.e., t3=0, in STEP S606. Otherwise (i.e., the determination result of STEP S607 is “YES”), in STEP S608, a malfunction detecting unit outputs a malfunction notification signal by which operators of the electrical apparatus may know that a malfunction of the electrical apparatus has occurred, and controls a clock pulse generator to stop output of the PWM signal.

The above mentioned upper limit VS+0.5 V and lower limit Vs−0.5 V are just examples for purposed of illustration of the predetermined duty ratio range. Similar to the third embodiment of the present invention, both the upper and lower limits of the predetermined duty ratio range and the predetermined time period may be set based on actual needs.

In so doing, the malfunction detecting unit according to the variant example of the third embodiment of the present invention detects the relationship of the duty ratio D of the PWM signal and the predetermined duty ratio range very predetermined detection time period, for example, 10 ms. If the number of times successively detecting that the duty ratio D of the PWM signal is out of the predetermined duty ratio range is greater than a predetermined number of times, for example, 50, then that means the duty ratio of the PWM signal is out of the predetermined duty ratio range, and the predetermined time period, for example, 500 ms, expires. As a result, the malfunction detecting unit outputs a malfunction notification signal, and controls a clock pulse generator to stop output of the PWM signal.

According to the above description, those people in the art should understand that by using a CPU and software to output a PWM signal and applying this kind of output method to a stabilized voltage power supply, it is possible to achieve a stabilized voltage output function and a feedback control function being the same with those of a stabilized voltage power supply having a PWM_IC, in the conventional techniques. In addition, by effectively utilizing a CPU that originally exists in an electrical apparatus, it is possible to use the CPU to replace the PWM_IC in the other main power supply as described above; the advantages of this kind of configuration are more apparent in an electrical apparatus having two or more main power supplies. As a result, this kind of configuration may dramatically simplify a structure of the electrical apparatus, and decrease its manufacturing cost.

On the other hand, the stabilized voltage power supply according to the embodiments of the present invention may provide various malfunction detecting approaches that may be applied to an electrical apparatus. This, however, is difficult to achieve in a stabilized voltage power supply adopting a PWM_IC, in the conventional techniques.

While the present invention is described with reference to the specific embodiments chosen for purpose of illustration, it should be apparent that the present invention is not limited to these embodiments, but numerous modifications could be made thereto by those people skilled in the art without departing from the basic concept and scope of the present invention.

The present application is based on Chinese Priority Patent Application No. 201110056494.1 filed on Feb. 28, 2011, the entire contents of which are hereby incorporated by reference.

What is claimed is:

1. A stabilized voltage power supply comprising:
an alternate current voltage to direct current voltage (A/D) converting circuit, a control switch, a final converting circuit, a feedback unit, and a pulse width modulation (PWM) signal output unit,
wherein,
the A/D converting circuit is configured to convert an alternate current voltage received from an external power supply to an initial direct current voltage;
the PWM signal output unit is configured to generate and output a PWM signal;
the control switch is configured to alternatively carry out, based on control of the received PWM signal, switching between a turn-on state and a turn-off state so as to convert the initial direct current voltage to a pulse voltage whose duty ratio is the same with that of the PWM signal;
the final converting circuit is configured to convert the pulse voltage to a final direct current voltage, and output the final direct current voltage to an external load via an output terminal, wherein, the final direct current voltage changes in a direction being the same with that of the duty ratio of the PWM signal; and
the feed unit is configured to feed the final direct current voltage back to the PWM signal output unit, and include
a sampling unit configured to obtain a sample voltage from the output terminal of the final converting circuit, proportional to the final direct current voltage, and carry out alternate current voltage to direct current voltage (A/D) conversion with regard to the obtained sample voltage;
a voltage comparing unit configured to perform comparison between the sample voltage after the A/D conversion and a digital reference voltage; and
a duty ratio adjusting unit configured to adjust, based on the comparison result of the voltage comparing unit, the duty ratio of the PWM signal, wherein,
if the sample voltage after the A/D conversion is equal to the reference voltage, then the duty ratio adjusting unit does not change the duty ratio of the PWM signal;
if the sample voltage after the A/D conversion is greater than the reference voltage, then the duty ratio adjusting unit decreases the duty ratio of the PWM signal by a first predetermined value; and
if the sample voltage after the A/D conversion is less than the reference voltage, then the duty ratio adjusting unit increases the duty ratio of the PWM signal by a second predetermined value.

2. The stabilized voltage power supply according to claim 1, further comprising a photoelectric coupler, wherein:
the photoelectric coupler is configured to include a high level terminal on an output side, a low level terminal on the outside side, a high level terminal on an input side, and a low level terminal on the input side,
wherein,
the high level terminal on the output side is connected to a control terminal of the control switch, and connected to an output terminal of the D/A converting circuit via a first resistance;
the low level terminal on the output side is connected to ground;
the high level terminal on the input side is connected to the output terminal of the final converting circuit via a second resistance; and
the low level terminal on the input side is connected to an output terminal of the PWM signal output unit.

3. The stabilized voltage power supply according to claim 1, further comprising a malfunction detecting unit, wherein:
if the malfunction detecting unit detects that the sample voltage is out of a predetermined voltage range including the reference voltage, and a predetermined time period expires, then the malfunction detecting unit outputs a malfunction notification signal, and stops output of the PWM signal.

4. The stabilized voltage power supply according to claim 3, wherein:
the malfunction detecting unit detects, every predetermined detection time period, a relationship between the sample voltage and the predetermined voltage range; if the number of times continuously detecting that the sample voltage is out of the predetermined voltage range is greater than a predetermined number of times, then that means the sample voltage is out of the predetermined voltage range, and the predetermined time period expires,
wherein,
the predetermined time period is equal to a value of multiplying the predetermined detection time period by the predetermined number of times.

5. The stabilized voltage power supply according to claim 1, further comprising a malfunction detecting unit, wherein:
if the malfunction detecting unit detects that the duty ratio of the PWM signal is out of a predetermined duty ratio range including a duty ratio corresponding to the reference voltage, and a predetermined timer period expires, then the malfunction detecting unit outputs a malfunction notification signal, and stops output of the PWM signal.

6. The stabilized voltage power supply according to claim 5, wherein:
the malfunction detecting unit detects, every predetermined detection period, a relationship between the duty ratio of the PWM signal and the predetermined duty ratio range; if the number of times continuously detecting that the duty ratio of the PWM signal is out of the predetermined duty ratio range is greater than a predetermined number of times, then that means the duty ratio of the PWM signal is out of the predetermined duty ratio range, and the predetermined time period expires,
wherein,
the predetermined time period is equal to a value of multiplying the predetermined detection time period by the predetermined number of times.

7. The stabilized voltage power supply according to claim 1, wherein:
the first and second predetermined values are in predetermined proportion to the sample voltage and the reference voltage, respectively.

8. The stabilized voltage power supply according to claim 1, wherein:
the first and second predetermined values are in predetermined proportion to the duty ratio of the PWM signal currently being adjusted, respectively.
